(19) United States
(12) Patent Application Publication
(10) Pub. No.: US 2007/0212911 A1
(43) Pub. Date: Sep. 13, 2007

(54) Retainer for use with a ring shaped member

(76) Inventor: Josephine M. Qualiana, Concord, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/710,265

(22) Filed: Feb. 23, 2007

Related U.S. Application Data
(60) Provisional application No. 60/775,854, filed on Feb. 23, 2006.

(51) Int. Cl. H01R 13/62

(52) U.S. Cl. 439/159

(57) ABSTRACT

A retainer for a ring shaped member is provided with a spine portion, first and second side portions, and at least one ring member hole. The spine portion includes opposed first and second side edges. The first side portion extends laterally from the first side edge and the second side portion extends laterally from the second side edge. The first and second side portions define a retaining cavity having an insertion portion opposite the spine portion for receiving one or more items between the first and second side portions. The at least one ring member hole is disposed in at least one of the first and second side portions for receiving a ring member therethrough. At least one of the first and second side portions is biased inward between the spine and the outer opening, such that the insertion portion in configured to retain one or more items in the retaining cavity. At least one of the spine portion, the first side portion, and the second side portion is resiliently flexible such that the first and second side portions are configured to spread apart at the insertion portion to allow at least one of the one or more items to slide therethrough.

### CROSS REFERENCE TO RELATED APPLICATION

This application claims the benefit of U.S. Provisional Application Ser. No. 60/775,854, entitled “CLUB CARDS KEY CHAIN” and filed Feb. 23, 2006, the entire disclosure of which is hereby incorporated by reference, to the extent that it is not conflicting with the present application.

### BACKGROUND

Various cards, such as, for example, preferred customer cards, club membership cards, discount or promotional “punch” cards, and credit cards, have been adapted to be secured to a key ring by providing the cards in a smaller size (relative to a driver's license or typical credit card) and with a hole at an end portion of the card for retaining the card on a key ring. Securing these cards to a key ring, may, for example, improve ease of access and convenience of use of the cards, and may prevent accidental loss of the cards. With the popularity of these types of cards, the inclusion of several such cards on a user's key chain is not uncommon. This may result in a keychain that is disorganized and/or unwieldy. Also, repeated impacts of the cards with the user's keys and other items in a user's purse or pocket may damage the cards, impairing their use (particularly if the card includes a bar code or magnetic strip for electronic scanning).

### SUMMARY

The present application relates to a retainer for assembly with a ring shaped member, such as, for example, the key ring of a key chain, for retaining one or more items secured to the ring shaped member, such as, for example, one or more cards (such as preferred customer cards or membership cards).

In one embodiment, a retainer for a ring shaped member is provided with a spine portion, first and second side portions, and at least one ring member hole. The spine portion includes opposed first and second side edges. The first side portion extends laterally from the first side edge and the second side portion extends laterally from the second side edge. The first and second side portions define a retaining cavity having an insertion portion opposite the spine portion for receiving one or more items between the first and second side portions. The at least one ring member hole is disposed in at least one of the first and second side portions for receiving a ring member therethrough. At least one of the first and second side portions is biased inward between the spine and the outer opening, such that the insertion portion in configured to retain one or more items in the retaining cavity. At least one of the spine portion, the first side portion, and the second side portion is resiliently flexible such that the first and second side portions are configured to spread apart at the insertion portion to allow at least one of the one or more items to slide therethrough.

### BRIEF DESCRIPTION OF THE DRAWINGS

Features and advantages of the invention will become apparent from the following detailed description made with reference to the accompanying drawings, wherein:

FIG. 1 illustrates a rear perspective view of a card retainer;

FIG. 2 illustrates a front perspective view of a card retainer with key ring;

FIG. 3 illustrates a rear perspective view of the card retainer with key ring of FIG. 2; and

FIG. 4 illustrates a rear perspective view of the card retainer with key ring of FIG. 2, with key and cards secured to the key ring.

### DETAILED DESCRIPTION

This Detailed Description of the Invention merely describes embodiments of the invention and is not intended to limit the scope of the invention in any way. Indeed, the invention as described is broader than and unlimited by the preferred embodiments, and the terms used have their full ordinary meaning.

While the specification and illustrated embodiments of the present application refer specifically to a card retainer for use with a key ring, many of the inventive aspects of the present application may likewise be applied to other applications, such as, for example, retainers for storing other items, such as, for example, keys, fabric or wallpaper samples, or storage envelopes, and retainers for securing to other items, such as, for example, binders or other items having loop or ring shaped portions of various shapes.

The present application contemplates a card retainer for use with a key ring to retain one or more cards secured to the key ring, for example, to prevent damage to the cards or to provide for organized retention of the cards. In one embodiment, first and second side portions extend from the side edges of a rear spine portion to define an internal cavity of the retainer. Outermost edges of the first and second side portions define an insertion portion, configured to receive one or more cards therethrough for receipt of the cards in the internal cavity of the retainer. According to an inventive aspect of the present application, the card retainer may be shaped to securely retain the cards within an internal cavity of the retainer, while allowing the cards to be easily and conveniently slid out of the retainer for quick use. In one such embodiment, one or both of the first and second side portions may be biased or contoured inward such that the insertion portion is narrower than the spine portion. The insertion portion may comprise a narrow gap between the outer edges of the first and second side portions. In another embodiment, the first and second side portions may be biased into contact with each other. By providing a narrow gap or no gap between the side portions, cards retained within the card retaining cavity are secured within the cavity and prevented from slipping out of the cavity until use of the card or cards is desired.

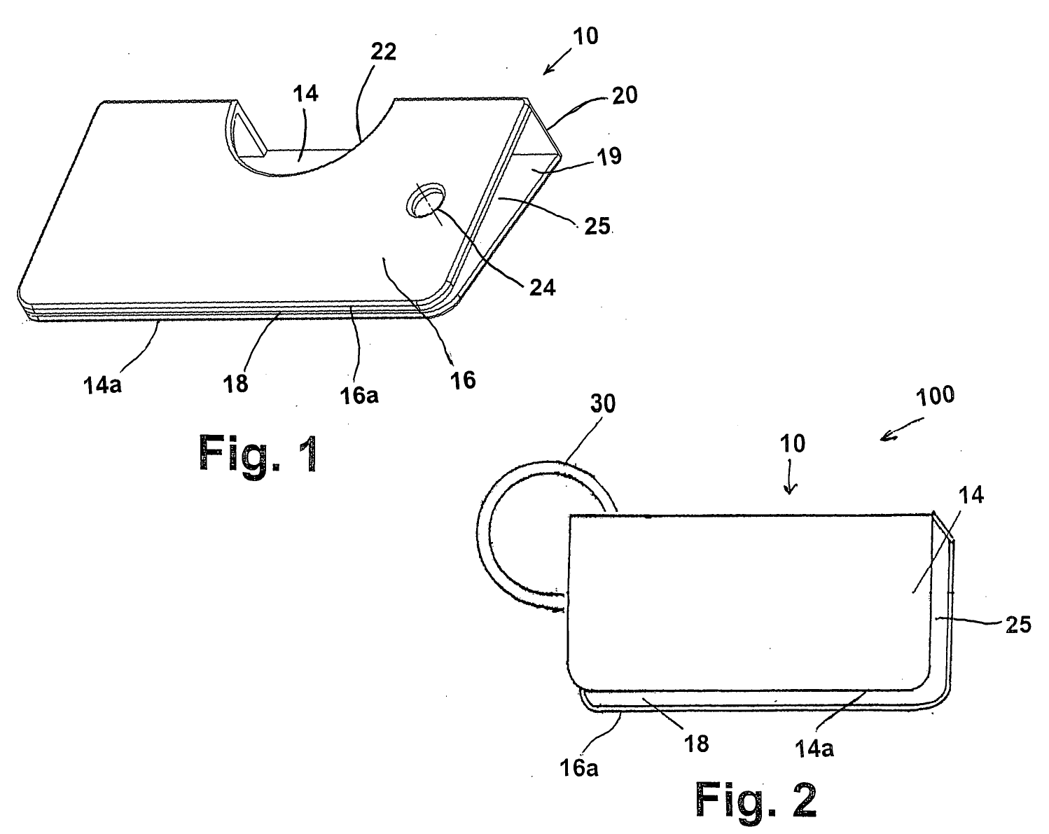

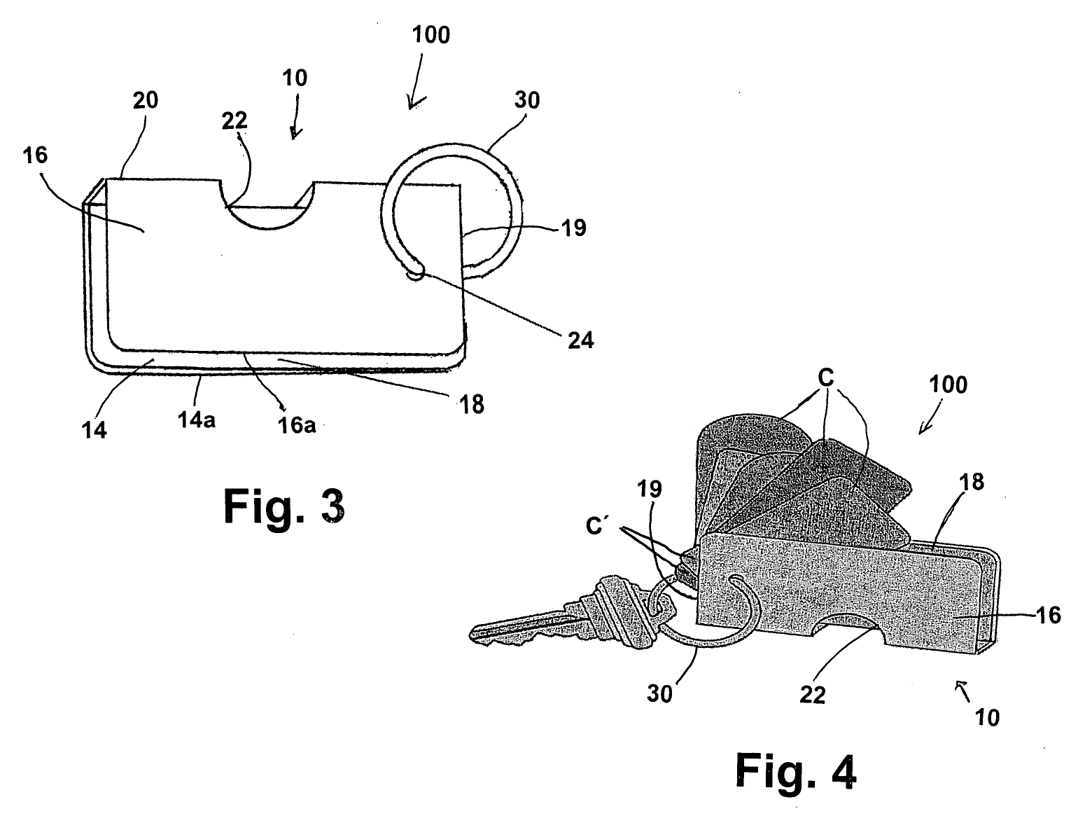

FIGS. 1-4 illustrate exemplary card retainers 10 for a key chain 100 (shown in FIGS. 2-4). The card retainer 10 includes a spine portion 20 and first and second side portions 14, 16 that extend laterally from the spine portion 20 to define a card retaining cavity 25. The exemplary side portions 14, 16 are biased inwards, such that outer edges 14a, 16a define a narrow insertion portion 18, which may, but need not, include a narrow gap between the outer edges 14a, 16a. As one example, the insertion portion may include a gap of approximately 1/64 inch between the outer edges 14a, 16a of the first and second side portions. While the spine portion 20 and side portions 14, 16 may be provided with many different shapes and contours, in the illustrated embodiment, the three portions 20, 14, 16 are substantially planar members, such that the exemplary retainer 10 resembles a loose-leaf binder.

To secure a card retainer 10 to a key ring 30 of a key chain 100, the card retainer 10 may include a key ring hole 24 in one or both of the first and second side portions 14, 16, through which the key ring 30 may freely pass. While the illustrated key ring 30 is circular in shape, many different shapes of key rings may be used, including, for example, oval shaped key rings. In the illustrated embodiment, a key ring hole 24 is disposed on the second side portion 16. To properly align one or more cards with the card retainer 10, the key ring hole or holes 24 may be positioned on the side portion 14, 16 such that a card C (see FIG. 4), when aligned on the key ring 30 with the insertion portion 18 of the card retainer 10, may be pivoted about the key ring 30 and through the insertion portion 18 to be fully retained within the card retaining cavity 25. Since many key ring type cards include a key ring hole at one end of the card that is centered across the width of the card, the key ring hole or holes 24 on the card retainer side portion or portions 14, 16 may similarly be positioned at one end of the side portion 14, 16 and approximately centered across the width of the side portion 14, 16, such that the retained card is aligned with and fully retained within the card retaining cavity 25.

While the card retainer 10 and its side portions 14, 16 may be provided in a range of sizes, it may be desirable to provide a card retainer 10 having side portions 14, 16 large enough to enclose a range of sizes and shapes of key ring-type cards, while being small enough to conveniently fit in a user's purse or pocket. As one example, a card retainer 10 may be provided with side portions 14, 16 having a length of approximately 2¾ inches and a width of approximately 1⅜ inches, and a spine portion 20 having a width of approximately 7/16 inches, with the spine portion 20 and first and second side portions 14, 16 being approximately 3/64 inches thick. This exemplary card retainer 10 may accommodate at least six key ring-type cards, such as, for example, preferred customer cards or membership cards.

To insert a card into the cavity 25 (or to remove a card from the cavity 25), the retainer 10 may be configured to open or expand the insertion portion 18 to allow one or more cards to slide through. In one embodiment, at least one of the spine portion 20, the first side portion 14, and the second side portion 16 may be resiliently flexible, such that the first and second side portions 14, 16 may be spread apart from each other enough to allow one or more cards to slide through the insertion portion 18 to allow for storage in or removal from the card retaining cavity 25 of the retainer 10. To provide for such resilient flexibility, all or part of the retainer 10 may be manufactured in a resilient, flexible material, such as, for example, plastic. The card retainer may, but need not, be provided as an integral, one piece molded plastic member, as shown in FIGS. 1-4. While the insertion portion 18 may be broadened or expanded by grasping the side portions 14, 16 and pulling them apart, the side portions 14, 16 may also be spread apart by pushing or sliding one or more cards into the insertion portion 18, such that the card or cards force the side portions apart enough the allow the card or cards to slide through. As shown in FIG. 4, since both the card retainer 10 of the illustrated embodiment and the cards C are retained on the key ring 30 by aligned key ring holes, an end portion C′ of a card C will first be received into the card retaining cavity 25 through an open end gap 19 between the first and second faces 14, 16 when the card C is aligned on the key ring 30 with the insertion portion 18. When the card C is rotated into the card retaining cavity 25, the end portion C′ of the card C may engage the insertion portion 18 from within the card retaining cavity 25 to spread apart the first and second side portions 14, 16 and broaden the insertion portion 18 to receive the rest of the card C therethrough.

To slide one or more retained cards C out of the card retaining cavity 25, one or more cut-outs may be provided in the retainer 10 to allow a user to grasp a portion of the retained card or cards to slide the card or cards through the insertion portion 18 and out of the retainer 10. The cut-outs may be provided in one or more of the spine portion 20, the first side portion 14, and the second side portion 16, and may span across more than one of these three portions 20, 14, 16. In the illustrated embodiment, cut-out portion 22 extends from the spine portion 20 into the second side portion 16 to provide access to the retained cards C.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A card retainer for a key ring, comprising:
a spine portion including opposed first and second side edges;
a first side portion extending laterally from the first side edge and a second side portion extending laterally from the second side edge, wherein the first and second side portions define a card retaining cavity having an insertion portion opposite the spine portion for receiving one or more cards between the first and second side portions; and
at least one key ring hole disposed in at least one of the first and second side portions for receiving a key ring therethrough;
wherein at least one of the first and second side portions is biased inward between the spine and the outer opening, such that the insertion portion in configured to retain one or more cards in the card retaining cavity, and
wherein at least one of the spine portion, the first side portion, and the second side portion is resiliently flexible such that the first and second side portions are configured to spread apart at the insertion portion to allow at least one of the one or more cards to slide therethrough.

2. The card retainer of claim 1, further comprising a cut-out portion disposed on at least one of the spine portion, the first side portion, and the second side portion, the cut-out portion being configured to permit access to at least one of the one or more cards for sliding the at least one card out of the card retaining cavity.

3. The card retainer of claim 2, wherein the cut-out portion is disposed on the spine portion and one of the first and second side portions.

4. The card retainer of claim 1, wherein the first and second side portions are biased inward.

5. The card retainer of claim 1, wherein the spine portion, the first side portion, and the second side portion are integral with each other.

6. The card retainer of claim 1, wherein the spine portion, the first side portion, and the second side portion are formed from a single piece of plastic.

7. The card retainer of claim 1, wherein the first and second side portions comprise planar members.

8. The card retainer of claim 1, further comprising an open end portion between the first and second side portions and proximate to the at least one key ring hole, the open end portion being sized to receive an end portion of a card therethrough.

9. A method for retaining one or more cards on a key ring, the method comprising:
securing the one or more cards to the key ring, such that the key ring passes through a corresponding hole in each of the one or more cards;
securing a card retainer to the key ring, such that the key ring passes through at least one corresponding hole in the card retainer;
positioning the one or more cards on the key ring to align with an insertion portion between first and second side portions of the card retainer;
rotating the one or more cards about the key ring to engage the one or more cards with the insertion portion;
sliding the one or more cards through the insertion portion and into a card retaining cavity; and
allowing at least one of first and second opposed side portions of the card retainer to bias inward to retain the one or more cards in the card retaining cavity.

10. The method of claim 9, wherein allowing at least one of first and second opposed sides of the card retainer to bias inward to retain the one or more cards in the card retaining cavity comprises squeezing the first and second opposed sides of the card retainer against the one or more cards in the card retaining cavity.

11. The method of claim 9, wherein sliding the one or more cards through the insertion portion and into the card retaining cavity comprises flexing at least one of the first and second side portions outward.

12. The method of claim 9, wherein positioning the one or more cards on the key ring to align with an insertion portion between first and second side portions of the card retainer comprises receiving an end portion of the one or more cards into an open end portion of the retainer between the first and second side portions.

13. A card retaining key chain, comprising:
a ring portion; and
a card retainer comprising:
a spine portion including opposed first and second side edges;
a first side portion extending laterally from the first side edge and a second side portion extending laterally from the second side edge, wherein the first and second side portions define a card retaining cavity having an insertion portion opposite the spine portion for receiving one or more cards between the first and second side portions; and
at least one key ring hole disposed in at least one of the first and second side portions, wherein the ring portion passes through the at least one key ring hole;
wherein at least one of the first and second side portions is biased inward between the spine and the outer opening, such that the insertion portion in configured to retain one or more cards in the card retaining cavity, and
wherein at least one of the spine portion, the first side portion, and the second side portion is resiliently flexible such that the first and second side portions are configured to spread apart at the insertion portion to allow at least one of the one or more cards to slide therethrough.

14. The key chain of claim 13, wherein the card retainer further comprises a cut-out portion disposed on at least one of the spine portion, the first side portion, and the second side portion, the cut-out portion being configured to permit access to at least one of the one or more cards for sliding the at least one card out of the card retaining cavity.

15. The key chain of claim 14, wherein the cut-out portion of the card retainer is disposed on the spine portion and one of the first and second side portions.

16. The key chain of claim 13, wherein the first and second side portions of the card retainer are biased inward.

17. The key chain of claim 13, wherein the card retainer is a one piece member.

18. The key chain of claim 13, wherein the card retainer is formed from a single piece of plastic.

19. The key chain of claim 13, wherein the first and second side portions comprise planar members.

20. The key chain of claim 13, wherein the card retainer further comprises an open end portion between the first and second side portions and proximate to the at least one key ring hole, the open end portion being sized to receive an end portion of a card therethrough.
